(19) United States
(12) Patent Application Publication
(10) Pub. No.: US 2025/0110416 A1
(43) Pub. Date: Apr. 3, 2025

(54) METHODS OF PREPARING AN ORGANIC PHOTOCONDUCTOR DRUM HAVING AN OVERCOAT TO MITIGATE CLEANER BLADE FLIP

(71) Applicant: LEXMARK INTERNATIONAL, INC., LEXINGTON, KY (US)

(72) Inventors: MARK THOMAS BELLINO, LOVELAND, CO (US); WEIMEI LUO, LAFAYETTE, CO (US); CHRISTOPHER DAVID STRACK, LEXINGTON, KY (US)

(21) Appl. No.: 18/904,467

(22) Filed: Oct. 2, 2024

Related U.S. Application Data
(60) Provisional application No. 63/542,125, filed on Oct. 3, 2023.

(51) Int. Cl. G03G 5/147

(52) U.S. Cl. CPC G03G 5/14773; G03G 5/14704; G03G 5/1476; G03G 5/14769

(57) ABSTRACT

A method of preparing a photoconductor drum according to one example embodiment includes preparing a curable overcoat composition including solids content mixed with an organic solvent. The solids content includes about 60 percent to about 95 percent by weight of a urethane resin, about 5 percent to about 40 percent by weight of nano metal oxide particles, and about 0.1 percent to about 5 percent by weight of a silicone additive selected from one or more of polydimethyl siloxane or a phenyl-modified silicone derivative of polydimethyl siloxane. The method includes coating the overcoat composition onto the photoconductor drum as an outmost layer of the photoconductor drum and curing the overcoat composition.

### CROSS REFERENCES TO RELATED APPLICATIONS

This application claims priority to U.S. Provisional Patent Application Ser. No. 63/542,125, filed Oct. 3, 2023, entitled “Organic Photoconductor Drum Having Overcoat to Mitigate Cleaner Blade Flip in a Toner Cartridge,” the content of which is hereby incorporated by reference in its entirety.

### BACKGROUND

### 1. Field of the Disclosure

The present disclosure relates generally to electrophotographic image forming devices and more particularity to an organic photoconductor drum having an overcoat to mitigate cleaner blade flip.

### 2. Description of the Related Art

Image forming devices such as copiers, laser printers, facsimile machines, and the like, include a photoconductor drum having a rigid cylindrical surface that is coated along a defined length of its outer surface. The surface of the photoconductor drum is charged to a uniform electrical potential and then selectively exposed to light in a pattern corresponding to an original image to be printed. Those areas of the photoconductor surface exposed to light are electrically discharged forming a latent electrostatic image on the outer surface of the photoconductor drum. A charged developer material, such as toner, is brought into contact with the outer surface of the photoconductor drum by a developer roll such that the charged toner attaches to the discharged areas of the outer surface of the photoconductor drum.

The toner on the photoconductor drum is then transferred, directly or indirectly by an intermediate transfer member, to a media sheet. During transfer of the toner from the photoconductor drum, some toner may not be transferred and may remain on the outer surface of the photoconductor drum. If this residual toner is not removed from the outer surface of the photoconductor drum, it may contaminate other components, such as a charge roll, which charges the outer surface of the photoconductor drum, or inadvertently transfer to a subsequent media sheet resulting in print defects. Accordingly, removal of residual toner from the outer surface of the photoconductor drum is necessary prior to preparing the photoconductor drum to receive a new image.

Residual toner may be removed from the outer surface of the photoconductor drum by a cleaner blade having an edge that contacts the outer surface of the photoconductor drum. However, a problem may arise if contact between the cleaner blade and the photoconductor drum as the photoconductor drum rotates causes the cleaner blade to deflect or “flip” from its operative position relative to the photoconductor drum, moving the cleaner blade to an inoperative position and rendering the cleaner blade unable to remove residual toner from the outer surface of the photoconductor drum. Organic photoconductor drums having a protective overcoat can be particularly prone to cleaner blade flip. Protective overcoats are used in organic photoconductors to provide the organic photoconductor with added wear-resistant properties such as extending the life of the organic photoconductor and reducing the mechanical abrasion of the outer surface of the photoconductor drum. The presence of the overcoat on the outer surface of the photoconductor drum often increases the torque between the cleaner blade and the outer surface of the photoconductor drum, thereby causing the cleaner blade to flip. Cleaner blade flip is highly undesirable, causing a complete print failure rendering the photoconductor drum unusable until the issue is resolved. For example, if the photoconductor drum is provided in a customer replaceable unit, replacement may be required.

Some approaches to reducing the occurrence of cleaner blade flip include minimizing the length of the cleaner blade, applying lubricants to the cleaner blade and/or the outer surface of the photoconductor drum, modifying the shape of the cleaner blade, and reducing forces applied at the ends of the cleaner blade by modifying blade support bracket and/or seal designs. These methods, however, often have drawbacks in terms of cost and reliability. Accordingly, a simple, low-cost solution to reduce the occurrence of cleaner blade flip is desired.

### SUMMARY

A method of preparing a photoconductor drum according to one example embodiment includes preparing a curable overcoat composition including solids content mixed with an organic solvent. The solids content includes about 60 percent to about 95 percent by weight of a urethane resin, about 5 percent to about 40 percent by weight of nano metal oxide particles, and about 0.1 percent to about 5 percent by weight of a silicone additive selected from one or more of polydimethyl siloxane or a phenyl-modified silicone derivative of polydimethyl siloxane. The method includes coating the overcoat composition onto the photoconductor drum as an outmost layer of the photoconductor drum and curing the overcoat composition.

A method of preparing a photoconductor drum according to one example embodiment includes preparing a curable overcoat composition including solids content mixed with an organic solvent. The solids content includes about 60 percent to about 95 percent by weight of a urethane resin, about 5 percent to about 40 percent by weight of nano metal oxide particles, and about 0.1 percent to about 5 percent by weight of a silicone additive selected from one or more of polymethylphenyl siloxane, polydimethyl siloxane, or polyphenyl-methylsiloxane. The method includes coating the overcoat composition onto the photoconductor drum as an outmost layer of the photoconductor drum and curing the overcoat composition.

In some embodiments, the silicone additive includes polymethylphenyl siloxane.

Embodiments include those wherein the solids content of the curable composition includes about 0.1 percent to about 2 percent by weight of the silicone additive.

In some embodiments, the urethane resin includes a urethane acrylate resin having at least six radical polymerizable functional groups.

In some embodiments, the nano metal oxide particles are selected from one or more of aluminum oxide, zirconium oxide, zinc oxide, indium oxide, indium tin oxide, lanthanum oxide, or antimony tin oxide.

Embodiments include those wherein a thickness of the overcoat layer is about 1 μm to about 6 μm.

Embodiments include those wherein the nano metal oxide particles are sized less than 400 nm.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a schematic view of an electrophotographic image forming device according to one example embodiment.

FIG. 2 is a cross-sectional view of a photoconductor drum of the electrophotographic image forming device according to one example embodiment.

FIG. 3 is a graph of electrical voltage versus discharge energy showing photo induced curves for photoconductor drums having different overcoat formulations.

FIG. 4 is a graph of torque versus time and number of revolutions of a photoconductor drum for photoconductor drums having different overcoat formulations with a cleaner blade coated with a corn starch lubricant.

FIG. 5 is a graph of torque versus time and number of revolutions of a photoconductor drum for photoconductor drums having different overcoat formulations without a lubricant on the cleaner blade.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense, and the scope of the present disclosure is defined only by the appended claims and their equivalents.

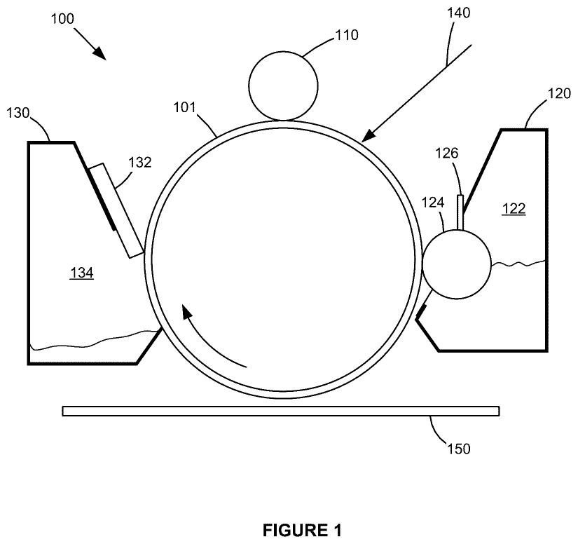

FIG. 1 illustrates a schematic representation of an example electrophotographic image forming device 100. Image forming device 100 includes a photoconductor drum 101, a charge roll 110, a developer unit 120, and a cleaner unit 130. The electrophotographic printing process is well known in the art and, therefore, is described briefly herein. During a print operation, charge roll 110 charges the outer surface of photoconductor drum 101. The charged outer surface of photoconductor drum 101 is then selectively exposed to a laser light source 140 to form an electrostatic latent image on photoconductor drum 101 corresponding to an image being printed. Charged toner from developer unit 120 is picked up by the latent image on photoconductor drum 101, creating a toned image.

Developer unit 120 includes a toner reservoir 122 having toner particles stored therein and a developer roll 124 that supplies toner from toner reservoir 122 to photoconductor drum 101. In one embodiment, developer roll 124 is electrically charged and electrostatically attracts the toner particles from toner reservoir 122. A doctor blade 126 (or other form of metering bar) disposed along developer roll 124 provides a substantially uniform layer of toner on developer roll 124 for subsequent transfer to photoconductor drum 101. As developer roll 124 and photoconductor drum 101 rotate, toner particles are electrostatically transferred from developer roll 124 to the latent image on photoconductor drum 101 forming a toned image on the outer surface of photoconductor drum 101. A toner adder roll (not shown) may also be provided to supply toner from toner reservoir 122 to developer roll 124. One or more agitators (not shown) may be provided in toner reservoir 122 to distribute the toner therein and to break up any clumped toner.

The toned image is then transferred from the outer surface of photoconductor drum 101 to print media 150 (e.g., paper), either directly by photoconductor drum 101 or indirectly by an intermediate transfer member. A fusing unit (not shown) fuses the toner to print media 150. A cleaner blade 132 of cleaner unit 130 removes any residual toner adhering to the outer surface of photoconductor drum 101 after the toner is transferred to print media 150. Waste toner from cleaner blade 132 is held in a waste toner reservoir 134 in cleaning unit 130 (or in a separate unit). The cleaned surface of photoconductor drum 101 is then ready to be charged again and exposed to laser light source 140 to continue the printing cycle.

The components of image forming device 100 may be replaceable as desired. For example, in one embodiment, developer unit 120 is housed in a replaceable unit with photoconductor drum 101, cleaner unit 130 and the main toner supply of image forming device 100. In another embodiment, developer unit 120 is provided with photoconductor drum 101 and cleaner unit 130 in a first replaceable unit while the main toner supply of image forming device 100 is housed in a second replaceable unit. In another embodiment, developer unit 120 is provided with the main toner supply of image forming device 100 in a first replaceable unit and photoconductor drum 101 and cleaner unit 130 are provided in a second replaceable unit. Any other combination of replaceable units may be used as desired. In some embodiments, photoconductor drum 101 is a permanent component of the image forming device 100.

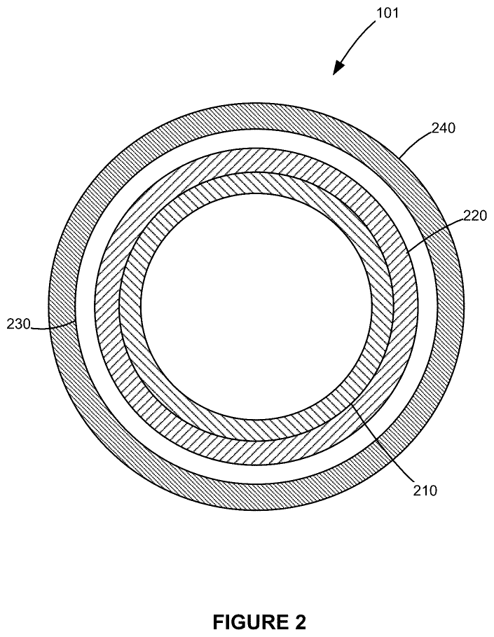

FIG. 2 illustrates an example photoconductor drum 101 in greater detail. In this example embodiment, photoconductor drum 101 is an organic photoconductor drum and includes a support element 210, a charge generation layer 220 disposed over the support element 210, a charge transport layer 230 disposed over the charge generation layer 220, and a protective overcoat layer 240 formed as an outermost layer of the photoconductor drum 101. Additional layers may be included between the support element 210, the charge generation layer 220 and the charge transport layer 230, including adhesive and/or coating layers.

Support element 210 is generally cylindrical, as illustrated in FIG. 2. However, support element 210 may assume other shapes or may be formed into a belt. In one example embodiment, support element 210 may be formed from an electrically conductive material, such as aluminum, iron, copper, gold, silver, etc., as well as alloys thereof. The surfaces of support element 210 may be treated, such as by anodizing and/or sealing. In some embodiments, support element 210 may be formed from a polymeric material and coated with an electrically conductive coating.

Charge generation layer 220 is designed for the photogeneration of charge carriers. Charge generation layer 220 may include a binder and a charge generation compound. The charge generation compound may be understood as any compound that generates a charge carrier in response to light. In one example embodiment, the charge generation compound may include a pigment dispersed evenly in one or more types of binders.

Charge transport layer 230 is designed to transport the generated charges. Charge transport layer 230 may include a binder and a charge transport compound. The charge transport compound may be understood as any compound that contributes to surface charge retention in the dark and to charge transport under light exposure. In embodiments, the charge transport compounds include organic materials capable of accepting and transporting charges. In one example embodiment, charge transport layer 230 includes a non-conductive polycarbonate matrix doped with charge transport moieties in the form of organic small molecules such as triarylamine.

In an example embodiment, charge generation layer 220 and charge transport layer 230 are configured to combine in a single layer. In such a configuration, the charge generation compound and charge transport compound are mixed in a single layer.

Overcoat layer 240 is designed to protect photoconductor drum 101 from wear and abrasion without materially altering the electrophotographic properties of photoconductor drum 101, thus extending the operational life of photoconductor drum 101. In some embodiments, overcoat layer 240 has a thickness of about 0.1 μm to about 10 μm. Specifically, overcoat layer 240 may have a thickness of about 1 μm to about 6 μm, such as about 1 μm to about 2 μm. The thickness of overcoat layer 240 is kept at a range that will not provide adverse effect to the electrophotographic properties of photoconductor drum 101. The thickness of overcoat layer 240 may be adjusted by either varying the amount of solvent used or changing the coat speed.

In an example embodiment, overcoat layer 240 includes a three-dimensional crosslinked structure formed from a curable composition. Overcoat layer 240 is prepared from a curable composition including nano metal oxide particles, a urethane resin, such as a urethane acrylate resin having at least six radical polymerizable functional groups, a silicone additive, such as a polydimethyl siloxane and/or one or more phenyl-modified silicone derivatives of polydimethyl siloxane, such as polymethylphenyl siloxane. The curable composition includes solids content of about 60 percent to about 95 percent by weight of the urethane resin, about 5 percent to about 40 percent by weight of the nano metal oxide particles, and about 0.1 percent to about 5 percent by weight of the silicone additive. In some embodiments, overcoat layer 240 does not have any component having charge transporting materials. In an example embodiment, the curable composition includes solids content of 70 percent to 95 percent by weight of the urethane resin, 5 percent to 30 percent by weight of the nano metal oxide particles, and 0.1 percent to 2 percent by weight of the silicone additive. Overcoat layer 240 may also include additional additives including, but not limited to, crosslinkable siloxanes, structured acrylic copolymers, and coating aids.

Usable nano metal oxide particles may be sized less than 400 nm. Nano metal oxides include, for example, aluminum oxide, zirconium oxide, zinc oxide, indium oxide, indium tin oxide, lanthanum oxide, antimony tin oxide or a combination of two or more thereof. A useful nano metal oxide particle is indium tin oxide sized 30 nm to 300 nm. An acceptable indium tin oxide (ITO) particle is sized less than 200 nm is available from Sigma-Aldrich, St. Louis, Missouri.

The at least six radical polymerizable functional groups of the urethane resin may be the same or different and may include one or more of acrylate, methacrylate, styrenic, allylic, vinylic, glycidyl ether, epoxy, or combinations thereof. A particularly useful urethane resin having at least six radical polymerizable functional groups includes a hexa-functional aromatic urethane acrylate resin, a hexa-functional aliphatic urethane acrylate resin, or a combinations thereof.

In an example embodiment, the hexa-functional aromatic urethane acrylate resin has the following structure:

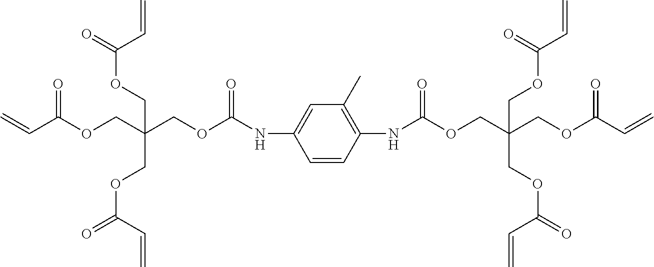 [SMILES: C=CC(=O)OCC(COC(=O)C=C)(COC(=O)C=C)COC(=O)Nc1ccc(NC(=O)OCC(COC(=O)C=C)(COC(=O)C=C)COC(=O)C=C)c(C)c1]

and is commercially available from Sartomer, Exton, Pennsylvania, under the trade name CN975.

In an example embodiment, the hexa-functional aliphatic urethane acrylate resin has the following structure:

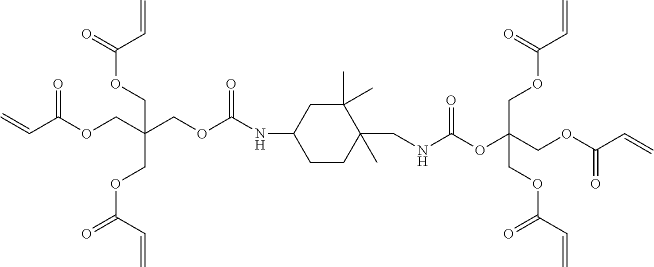 [SMILES: C=CC(=O)OCC(COC(=O)C=C)(COC(=O)C=C)COC(=O)NC1CCC(C)(CNC(=O)OC(COC(=O)C=C)(COC(=O)C=C)COC(=O)C=C)C(C)(C)C1]

and is commercially available from Cytec Industries, Woodland Park, New Jersey, under the trade name EBECRYL® 8301 or from Rahn AG., Switzerland under the trade name Genomer 4690.

Overcoat layer 240 includes a silicone additive, such as a polydimethyl siloxane and/or one or more phenyl-modified silicone derivatives of polydimethyl siloxane. In some embodiments, the silicone additive is a polymethylphenyl siloxane, for example, having the following structure:

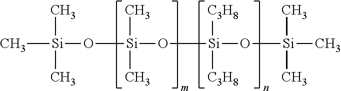

and commercially available from Shin-Etsu Silicones of America, Inc., Akron, Ohio, under the trade name F-5W-0, such as F-5W-0-100.

In another embodiment, the silicone additive is polydimethyl siloxane, for example, having the following structure:

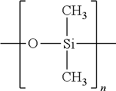

and commercially available from Sigma-Aldrich, St. Louis, Missouri, under the trade name DC200.

In another example embodiment, the silicone additive is polyphenyl-methylsiloxane, for example, having the following structure:

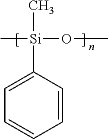

and commercially available from Sigma-Aldrich, St. Louis, Missouri, under the trade name AR200.

The curable composition of overcoat layer 240 may include additional additives, including, but not limited to, crosslinkable siloxanes, structured acrylic copolymers, and coating aids.

The crosslinkable siloxanes may include polyether modified acryl functional polydimethylsiloxane and/or polypropyleneoxide modified acryl functional polydimethylsiloxane. A suitable crosslinkable siloxane in overcoat layer 240 includes a crosslinkable polyether modified acryl functional polymethylsiloxane commercially available from BYK-Chemie, Wesel, Germany under the trade name BYK®-UV3500. The amount of the crosslinkable siloxane is about 0.1 percent to about 1.0 percent solids content by weight of the curable composition of overcoat layer 240, preferably about 0.2 percent to about 0.6 percent solids content by weight of the curable composition of overcoat layer 240. The addition of crosslinkable siloxanes greatly improves the stability of overcoat layer 240.

A suitable structured acrylic copolymer with pigment affinic groups is available from BYK-Chemie under the trade name DISPERBYK®-2025. The amount of the structured acrylic copolymer is about 0.5 percent to about 4.0 percent solids content by weight of the curable composition of overcoat layer 240, preferably about 1.0 percent to about 2.0 percent solids content by weight of the curable composition of overcoat layer 240. The addition of structured acrylic copolymers mitigates the agglomeration of the nano metal oxide particles, thereby improving the stability of overcoat layer 240.

The curable composition of overcoat layer 240 may include a coating aid, such as a surfactant, at an amount equal to or less than about 10 percent solids content by weight of the curable composition of overcoat layer 240. In some embodiments, the amount of coating aid additive is about 0.1 to about 5 percent solids content by weight of the curable composition of overcoat layer 240. The coating additive improves the coating uniformity of the curable composition of overcoat layer 240.

The curable composition of overcoat layer 240 is prepared by mixing the nano metal oxide particles, the urethane resin and the silicone additive in a solvent. The solvent may include an organic solvent. A crosslinkable siloxane and a structured acrylic copolymer may be added into the curable composition of overcoat layer 240. The curable composition of overcoat 240 is coated on the outermost surface of the photoconductor drum 101 through dipping or spraying. If the curable composition is applied through dip coating, an alcohol may be used as the solvent to minimize dissolution of the components of charge transport layer 230. The alcohol solvent may include isopropanol, methanol, ethanol, butanol, or combinations thereof. In an example embodiment, the solvent is ethanol.

The coated curable composition of overcoat layer 240 is then exposed to an electron beam or UV light of sufficient energy to induce formation of free radicals to initiate crosslinking of reactive binder(s) in overcoat layer 240. The exposed curable composition of overcoat layer 240 is then subjected to thermal cure to remove the solvent and annealed to relieve stresses in the coating.

### Preparation of Example Base Photoconductor

Photoconductor drums were formed using a cylindrical aluminum substrate, a charge generation layer coated onto the aluminum substrate, and a charge transport layer coated onto the charge generation layer.

The charge generation layer was prepared from a dispersion including type IV titanyl phthalocyanine, polyvinylbutyral, poly(methyl-phenyl) siloxane and polyhydroxystyrene at a weight ratio of 45:27.5:24.75:2.75 in a mixture of 2-butanone and cyclohexanone solvents. The polyvinylbutyral is available from Sekisui Chemical Co., Ltd., Tokyo, Japan, under the trade name BX-1. The charge generation dispersion was coated onto the aluminum substrate through dip coating and dried at 100° C. for 15 minutes to form the charge generation layer having a thickness of less than 1 μm, specifically a thickness of about 0.2 μm to about 0.3 μm.

The charge transport layer was prepared from a formulation including terphenyl diamine derivatives (200 g), polycarbonate A (365.4 g) and polycarbonate Z00 (365.4 g) as well as polysiloxane DC200 (0.06 g) in a mixed solvent of tetrahydrofuran (THF) and 1,4-dioxane. The charge transport formulation was coated on top of the charge generation layer and cured at 120° C. for 1 hour to form the charge transport layer having a thickness of about 14 μm as measured by an eddy current tester.

### Preparation of Comparative Example Photoconductor

The comparative example overcoat formulation was prepared as follows: 30% by weight indium tin oxide dispersion (18 g) (nano indium tin oxide particles dispersed in isopropanol), EBECRYL® 8301 hexa-functional aliphatic urethane acrylate resin (24.6 g), BYK®-UV3500 crosslinkable siloxane (0.06 g) and DISPERBYK®-2025 structured acrylic copolymer (0.6 g) mixed with 107 g of ethanol.

The comparative overcoat formulation was then coated through dip coating on the outer surface of the Example Base Photoconductor. The coated layer was subjected to an electron beam cure at 86 kGy and then thermally cured at 120° C. for 1 hour. The cured cross-linked layer forms the overcoat layer having a thickness of about 1.5 μm as measured by an eddy current tester. This photoconductor is the Comparative Example Photoconductor.

### Preparation of Example Photoconductor 1

The example overcoat formulation 1 was prepared as follows: 30% by weight indium tin oxide dispersion (18 g), EBECRYL® 8301 hexa-functional aliphatic urethane acrylate resin (24.6 g), BYK®-UV3500 crosslinkable siloxane (0.06 g), DISPERBYK®-2025 structured acrylic copolymer (0.6 g) and F-5W-0-100 polymethylphenyl silicone fluid (0.12 g, 0.4% of the total solid) were mixed with 107 g of ethanol.

The example overcoat formulation 1 was coated through dip coating on the outer surface of the Example Base Photoconductor. The coated layer was subjected to an electron beam cure at 86 kGy and then thermally cured at 120° C. for 1 hour. The cured cross-linked layer forms the overcoat layer having a thickness of about 1.5 μm as measured by an eddy current tester. This photoconductor is Example Photoconductor 1.

### Preparation of Example Photoconductor 2

The example overcoat formulation 2 was prepared as follows: 30% by weight indium tin oxide dispersion (18 g), EBECRYL® 8301 hexa-functional aliphatic urethane acrylate resin (24.6 g), BYK®-UV3500 crosslinkable siloxane (0.06 g), DISPERBYK®-2025 structured acrylic copolymer (0.6 g) and F-5W-0-100 polymethylphenyl silicone fluid (0.24 g, 0.8% of the total solid) were mixed with 107 g of ethanol.

The example overcoat formulation 2 was coated through dip coating on the outer surface of the Example Base Photoconductor. The coated layer was subjected to an electron beam cure at 86 kGy and then thermally cured at 120° C. for 1 hour. The cured cross-linked layer forms the overcoat layer having a thickness of about 1.5 μm as measured by an eddy current tester. This photoconductor is Example Photoconductor 2.

### Preparation of Example Photoconductor 3

The example overcoat formulation 3 was prepared as follows: 30% by weight indium tin oxide dispersion (18 g), EBECRYL® 8301 hexa-functional aliphatic urethane acrylate resin (24.6 g), BYK®-UV3500 crosslinkable siloxane (0.06 g), DISPERBYK®-2025 structured acrylic copolymer (0.6 g) and F-5W-0-100 polymethylphenyl silicone fluid (0.6 g, 2% of the total solid) were mixed with 107 g of ethanol.

The example overcoat formulation 3 was coated through dip coating on the outer surface of the Example Base Photoconductor. The coated layer was subjected to an electron beam cure at 86 kgy and then thermally cured at 120° C. for 1 hour. The cured cross-linked layer forms the overcoat layer having a thickness of about 1.5 μm as measured by an eddy current tester. This photoconductor is Example Photoconductor 3.

### Off-Line Electrical Discharge

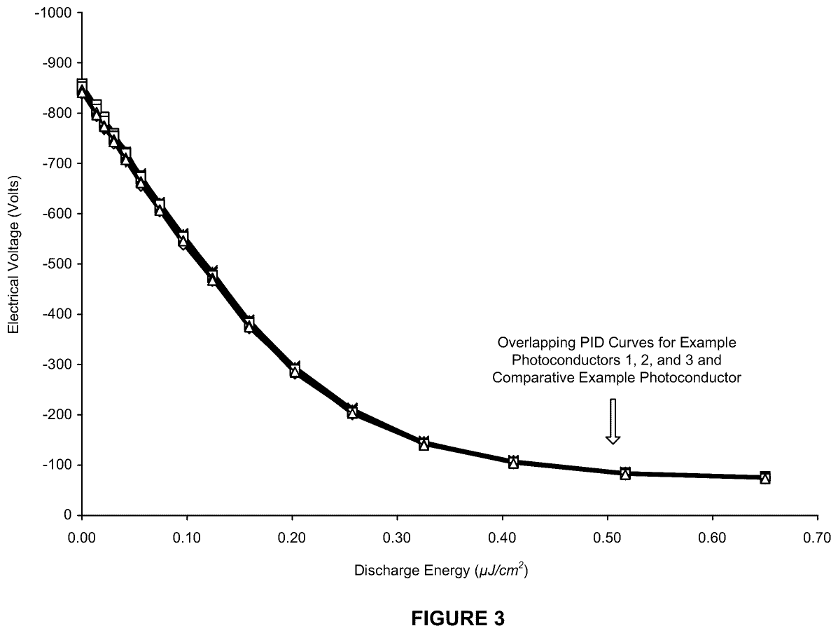

Photo-induced-discharge of Example Photoconductors 1, 2 and 3 and the Comparative Example Photoconductor were taken by an in-house tester (780 nm) with DC charging. The expose-to-develop time was set at 35 ms. The photoconductor drum surface charge was set at −850V. FIG. 3 shows that the addition of a polymethylphenyl silicone fluid additive to the overcoat formulation did not show a negative effect on the photo-induced-discharge (PID) for Example Photoconductors 1, 2 and 3 in comparison with the Comparative Example Photoconductor.

### Surface Energy

The contact angles of the outer surfaces of Example Photoconductors 1, 2 and 3 and the Comparative Example Photoconductor were measured with water and diiodomethane. The surface energy was then calculated for each. Contact angles were measured using a DSA100 drop shape analyzer from Kruess Scientific. The liquid droplet size was 1 μl, and ten measurements were taken per sample along the horizontal axis of the photoconductor drum with 1 cm separation for each measurement.

Table 1 below illustrates that the addition of a polymethylphenyl silicone fluid additive to the overcoat formulation did not result in lower surface energy for Example Photoconductors 1, 2 and 3 in comparison with the Comparative Example Photoconductor.

TABLE 1

| | Water contact | CH₂I₂ contact | Surface |
|---|---|---|---|
| | angle | angle | energy |
| | (degrees) | (degrees) | (mJ/m²) |
| Comparative | 99.02 | 64.29 | 26.53 |
| Example | | | |
| Photoconductor | | | |
| (sample 1) | | | |
| Comparative | 98.49 | 63.61 | 26.95 |
| Example | | | |
| Photoconductor | | | |
| (sample 2) | | | |
| Example | 100.72 | 61.72 | 27.74 |
| Photoconductor 1 | | | |
| (sample 1) | | | |
| Example | 101.73 | 62.48 | 27.25 |
| Photoconductor 1 | | | |
| (sample 2) | | | |
| Example | 106.67 | 62.89 | 26.92 |
| Photoconductor 2 | | | |
| (sample 1) | | | |
| Example | 105.66 | 62.85 | 26.94 |
| Photoconductor 2 | | | |
| (sample 2) | | | |
| Example | 109.39 | 54.62 | 32.12 |
| Photoconductor 3 | | | |
| (sample 1) | | | |
| Example | 111.59 | 54.91 | 32.23 |
| Photoconductor 3 | | | |
| (sample 2) | | | |

### Torque Test

A torque measurement robot was used to perform a cleaner blade flip test on Example Photoconductors 1, 2 and 3 and the Comparative Example Photoconductor.

An imaging basket containing photoconductor drum 101, charge roll 110, and cleaner unit 130, including cleaner blade 132, was installed in a torque robot carrier without a corresponding developer unit 120 and without toner present. A first series of tests was performed with a dry powder lubricant, cornstarch, applied to the cleaner blade 132 to reduce early life torque and cleaner blade flip. A second series of tests was performed without a dry powder lubricant applied to the cleaner blade 132. For each test, the torque robot carrier was positioned in the appropriate location on a base plate, and the drive coupler to the photoconductor drum was rotated by hand prior to beginning the test to remove any coupler backlash. Test parameters were as follows:
Photoconductor drum speed=148 rpm (equivalent to 42 pages per minute print speed) 3 steps to reach velocity
100 ms delay between steps

$$\begin{matrix}Motor resolution = 25 , 000 \\ Torque gain factor = 20 \\ Sampling rate = 100 / second \\ Sampling size = 100 \\ Test run time = 1800 seconds\end{matrix}$$

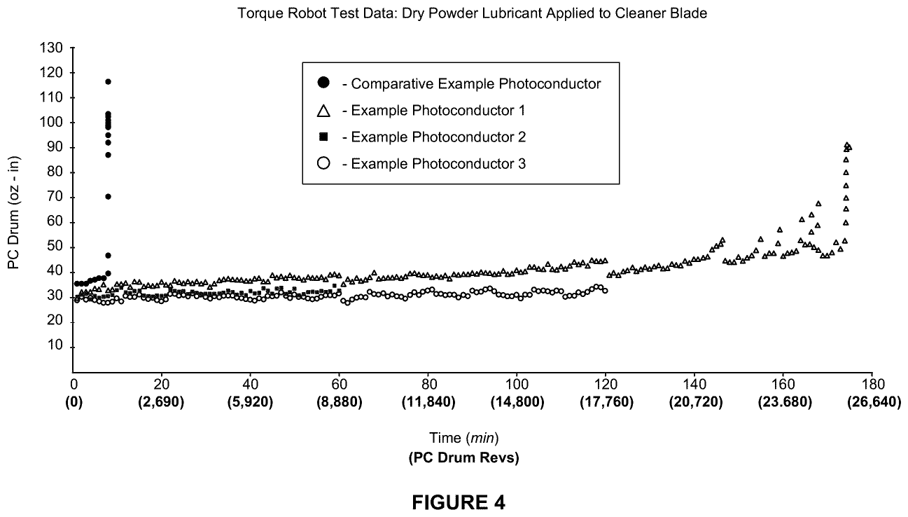

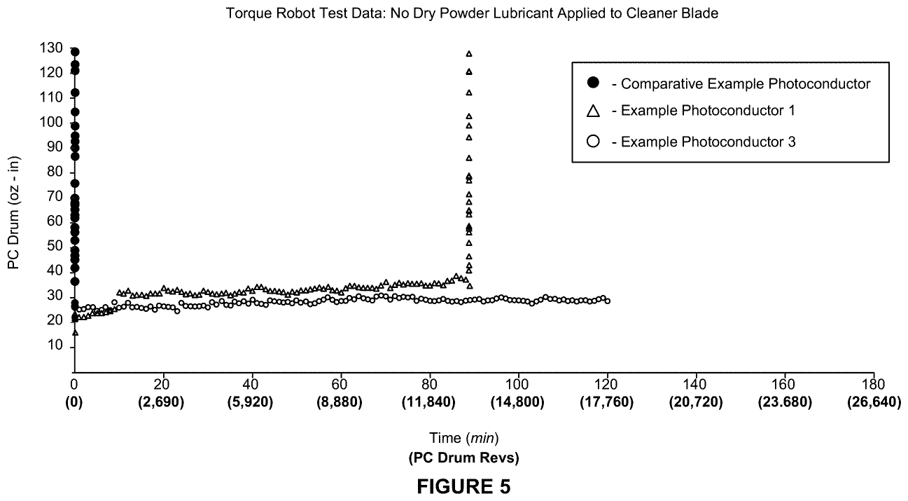

Once the test setup was complete, the torque test was initiated. Torque versus time data was collected for each photoconductor drum. The test data is shown in FIGS. 4 and 5. Visual observations of the photoconductor drum, cleaner blade, and charge roll were also made during testing and following the completion of each test. The drastic increase in torque for the Comparative Example Photoconductor shown in the first ten minutes of testing in FIG. 4 and at the outset of the testing shown in FIG. 5 leads to cleaner blade flip, which renders the photoconductor drum unusable until the issue is resolved. One can easily see in FIGS. 4 and 5 that the time for the steep increase in torque is significantly extended in Example Photoconductors 1, 2 and 3 having the polymethylphenyl silicone fluid additive in their overcoat formulations in comparison with the Comparative Example Photoconductor.

The inventors have observed that the inclusion of a silicone fluid additive, such as polydimethyl siloxane and/or one or more phenyl-modified silicone derivatives of polydimethyl siloxane, for example polymethylphenyl siloxane, in overcoat layer 240 surprisingly reduces the torque between photoconductor drum 101 and cleaner blade 132, thereby reducing the occurrence of cleaner blade flip. Photoconductor drum 101 with overcoat layer 240 containing a silicone fluid additive possesses excellent photo-induced-discharge characteristics. Additionally, overcoat layer 240 containing a silicone fluid additive possesses (1) excellent adhesion to the photoconductor surface, (2) optical transparency and (3) provides a photoconductor drum 101 that is resistant to cracking and crazing. Photoconductor drum 101 with overcoat layer 240 containing a silicone fluid additive shows excellent wear and abrasion resistance and electrical stability, even without the use of costly cross-linkable charge transport materials in overcoat layer 240. Moreover, embodiments of overcoat layer 240 containing a silicone fluid additive are cost effective to manufacture because they do not incorporate costly charge transporting materials in overcoat layer 240.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A method of preparing a photoconductor drum, comprising:
preparing a curable overcoat composition including solids content mixed with an organic solvent, the solids content includes:
about 60 percent to about 95 percent by weight of a urethane resin;
about 5 percent to about 40 percent by weight of nano metal oxide particles; and
about 0.1 percent to about 5 percent by weight of a silicone additive selected from one or more of polydimethyl siloxane or a phenyl-modified silicone derivative of polydimethyl siloxane;
coating the overcoat composition onto the photoconductor drum as an outmost layer of the photoconductor drum; and
curing the overcoat composition.

2. The method of claim 1, wherein the silicone additive includes polymethylphenyl siloxane.

3. The method of claim 1, wherein the solids content of the curable overcoat composition includes about 0.1 percent to about 2 percent by weight of the silicone additive.

4. The method of claim 1, wherein the urethane resin includes a urethane acrylate resin having at least six radical polymerizable functional groups.

5. The method of claim 1, wherein the nano metal oxide particles are selected from one or more of aluminum oxide, zirconium oxide, zinc oxide, indium oxide, indium tin oxide, lanthanum oxide, or antimony tin oxide.

6. The method of claim 1, wherein a thickness of the overcoat composition as the outmost layer of the photoconductor drum is about 1 μm to about 6 μm.

7. The method of claim 1, wherein the nano metal oxide particles are sized less than 400 nm.

8. A method of preparing a photoconductor drum, comprising:
preparing a curable overcoat composition including solids content mixed with an organic solvent, the solids content includes:
about 60 percent to about 95 percent by weight of a urethane resin;
about 5 percent to about 40 percent by weight of nano metal oxide particles; and
about 0.1 percent to about 5 percent by weight of a silicone additive selected from one or more of polymethylphenyl siloxane, polydimethyl siloxane, or polyphenyl-methylsiloxane;
coating the overcoat composition onto the photoconductor drum as an outmost layer of the photoconductor drum; and
curing the overcoat composition.

9. The method of claim 8, wherein the silicone additive includes polymethylphenyl siloxane.

10. The method of claim 8, wherein the solids content of the curable overcoat composition includes about 0.1 percent to about 2 percent by weight of the silicone additive.

11. The method of claim 8, wherein the urethane resin includes a urethane acrylate resin having at least six radical polymerizable functional groups.

12. The method of claim 8, wherein the nano metal oxide particles are selected from one or more of aluminum oxide, zirconium oxide, zinc oxide, indium oxide, indium tin oxide, lanthanum oxide, or antimony tin oxide.

13. The method of claim 8, wherein a thickness of the overcoat composition as the outmost layer of the photoconductor drum is about 1 μm to about 6 μm.

14. The method of claim 8, wherein the nano metal oxide particles are sized less than 400 nm.
